(19) United States
(12) Patent Application Publication
(10) Pub. No.: US 2016/0229089 A1
(43) Pub. Date: Aug. 11, 2016

(54) METHOD FOR MANUFACTURING A TOOL PLATE FOR TREATING A PRINTING SUBSTRATE, TOOL PLATE AND EMBOSSING DIE

(71) Applicant: HEIDELBERGER DRUCKMASCHINEN AG, HEIDELBERG (DE)

(72) Inventors: DUY LINH NGUYEN, REINHEIM (DE); MARTIN SCHMITT-LEWEN, HEIDELBERG (DE); THORSTEN EULER, DARMSTADT (DE); SIMON LOEPRICH, FRANKFURT AM MAIN (DE)

(21) Appl. No.: 15/016,497

(22) Filed: Feb. 5, 2016

(30) Foreign Application Priority Data
Feb. 11, 2015 (DE) 102015202382.6

(51) Int. Cl. B29C 33/38; B44B 5/02; B29C 33/42

(52) U.S. Cl. CPC B29C 33/3878; B29C 33/424; B44B 5/026; B29L 2031/757

(57) ABSTRACT

A method for manufacturing a tool plate for treating a printing substrate includes pressing a master die having a surface structure and a tool plate blank coated with a cured layer against one another in a pressing nip, trapping a curable layer therebetween. As a consequence, the curable layer is applied to the cured layer of the blank and receives a negative of the surface structure in a molding process. The curable layer is subsequently cured. A printing machine tool plate and an embossing die for embossing holograms are also provided.

### CROSS-REFERENCE TO RELATED APPLICATION

This application claims the priority, under 35 U.S.C. §119, of German application DE 10 2015 202 382.6, filed Feb. 11, 2015; the prior application is herewith incorporated by reference in its entirety.

### BACKGROUND OF THE INVENTION

### Field of the Invention

The present invention relates to a method for manufacturing a tool plate for treating a printing substrate, for instance an embossing die for embossing holograms. The invention also relates to a tool plate manufactured according to the method and an embossing die for holograms.

East German Patent Application DD 239 758 A5, corresponding to U.S. Pat. Nos. 4,551,297 and 4,634,484, discloses a method for creating an embossing roller wherein a synthetic resin is poured or spread onto a surface of a structured original in a layer of uniform thickness and is then hardened to form an embossing master, which is then stripped off the structured original. The synthetic resin is silicone rubber.

German Patent Application DE 10 2004 019 187 A1 discloses an embossing die for embossing optically diffractive relief structures having a refining layer which is initially generated on a master in a vapor deposition process. A metal layer is galvanically built up on top and is subsequently stripped off the master together with the refining layer.

German Patent Application DE 10 2007 062 123 A1 discloses an embossing die for creating a microstructure and a master foil for manufacturing the embossing die.

### SUMMARY OF THE INVENTION

It is an object of the invention to provide a method for manufacturing a tool plate for treating a printing substrate as well as a tool plate and an embossing die, which overcome the disadvantages of the heretofore-known methods, plates and dies of this general type.

With the foregoing and other objects in view there is provided, in accordance with the invention, a method for manufacturing a tool plate for treating a printing substrate. The method comprises the steps of pressing together in a pressing nip a master die having a surface structure and a blank of the tool plate coated with a cured layer while trapping a curable layer between the master die and the blank, applying the curable layer to the hardened layer of the blank to impart a negative of the surface structure to the curable layer in a molding process, and subsequently curing the curable layer.

The method of the invention provides a comparatively easy way of manufacturing tool plates.

In accordance with another mode of the invention, the master die is a plate or a foil.

In accordance with a further mode of the invention, the negative is a micro relief that is only visible or a haptic relief that is also perceptible to the touch.

In accordance with an added mode of the invention, the pressing nip is formed by a roller and a counter-element that has the shape of a plate or of a cylinder.

In accordance with an additional mode of the invention, the tool plate is an embossing plate and the blank is a printing master blank for an offset printing process performed without water or without dampening solution.

In accordance with yet another mode of the invention, the master die is a nickel master.

In accordance with yet a further mode of the invention, the cured layer and the curable layer are made of the same type of material, for instance of silicone.

With the objects of the invention in view, there is furthermore provided a printing press tool plate that is an embossing die for a micro-embossing process in a printing press and is manufactured in accordance with the method of the invention or in accordance with one of the further developments of the method of the invention.

With the objects of the invention in view, there is concomitantly provided an embossing die for embossing holograms comprising a plurality of cured layers, the uppermost of which is a silicone layer having a micro-relief for embossing the holograms. The embossing die of the invention may be manufactured in accordance with the method of the invention or in accordance with a further development thereof. The embossing die of the invention may be used for a micro-embossing process in a printing press. The embossing die of the invention may also be used in a micro-embossing process in an embossing machine.

Other features which are considered as characteristic for the invention are set forth in the appended claims.

Although the invention is illustrated and described herein as embodied in a method for manufacturing a tool plate for treating a printing substrate, a tool plate and an embossing die, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, sectional view of a nip roller unit applying a silicone layer to a tool plate blank while at the same time forming a micro-relief in the silicone layer; and

FIG. 2 is an elevational view illustrating the subsequent curing of the silicone layer of the tool plate manufactured in the nip roller unit.

### DETAILED DESCRIPTION OF THE INVENTION

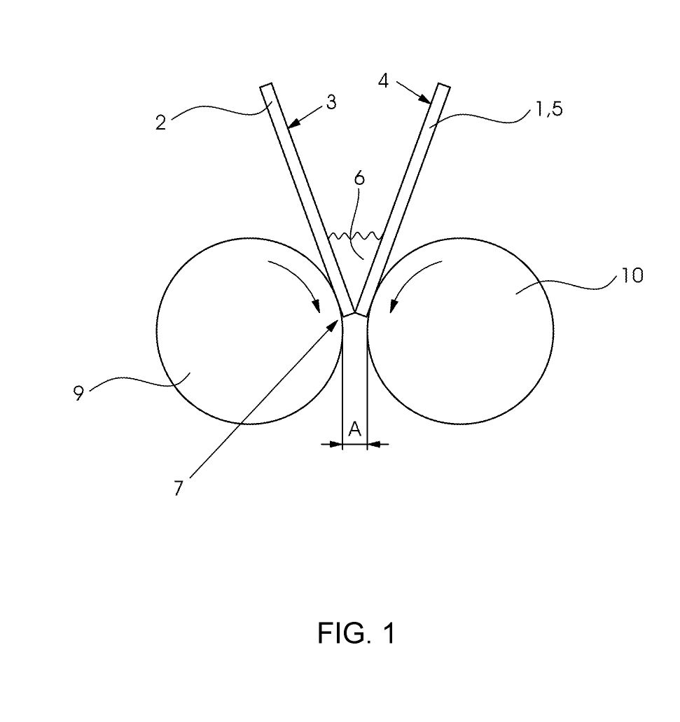

Referring now to the figures of the drawings in detail and first, particularly, to FIG. 1 thereof, there is seen a nip roller unit with a pressing nip 7 formed by a roller 9 and a counter-element 10. The counter-element 10 is a roller, i.e. it has a cylindrical shape. An adjustment of a nip width A of the pressing nip 7 is possible by moving the roller 9 relative to the counter-element 10 or by moving the latter relative to the roller 9.

A master die 2 and a blank 5 of a tool plate 1 to be manufactured are jointly placed in an introduction region of the pressing nip 7. A nickel plate may be used as the master die 2. The master die 2 has a surface structure 3 on its side facing the blank 5. The blank 5 may be a printing forme blank for a waterless offset printing process or for an offset printing process without dampening solution. The blank 5 has a carrier layer on which a cured layer 4 is disposed. The carrier layer may be a polyester layer. The master die 2 and the blank 5 are rectangular plates or foils that are 400 mm×500 mm in size.

A fluid volume of 50 ml of a curable layer 6 is introduced into the tip of the funnel-shaped inner space between the master die 2 and the blank 5. The curable layer 6 is formed of silicone or of silicone and a curing agent if it is a two-component system. In this stage of the process, the curable layer 6 is still liquid or viscous. The layer 4 disposed on the side of the blank 5 facing the master die 2 has already been cured and is likewise formed of silicone.

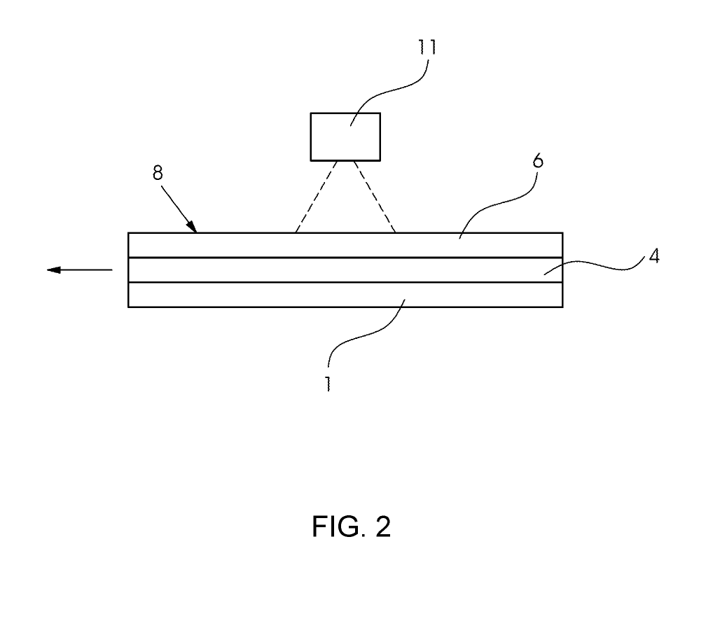

The master die 2, the blank 5 and the curable layer 6 are driven by the roller 9 and jointly pass through the pressing nip 7 at a speed of up to 40 m/min in a downward direction in terms of FIG. 1. In this process, the master die 2 and the blank 5 are placed flatly against one another along their entire length and the curable layer 6 is smoothened by fluid displacement to a thin film disposed between the master die 2 and the blank 5. The surface structure 3 is a relief for embossing the film formed by the curable layer 6. As a result of the embossing of the film, a negative 8 (see FIG. 2) of the surface structure 3 is created in the film.

Once the sandwich configuration formed of the master die 2, the blank 5 and the curable layer 6 has passed through the pressing nip 7, the sandwich configuration is set aside for a specific curing time of two to three minutes, for instance. During this curing period, the curable layer 6 that has been rolled smooth to form a film cures on the blank 5.

Subsequently the master die 2 is removed from the blank 5 while the curable layer 6, which has been cured in the meantime, remains on the blank 5 and separates from the master die 2. The adhesive forces between the curable layer 6, which has become sufficiently firm at this stage of the process, and the blank 5 are greater than the adhesive forces between the curable layer 6 and the master die 2 because the curable layer 6 and the cured layer 4 forming the outer surface of the blank 5 are made of the same type of material.

As is shown in FIG. 2, after the master die 2 has been removed from the blank 5, the surface of the latter carries a film in the form of the curable layer 6 that has been embossed with a negative 8 of the surface structure 3 (see FIG. 1). The complete curing of the film formed by the curable layer 6 may be assisted by an emitter 11. The emitter 11 may be a hot-air blower, for instance.

In accordance with an alternative, the film may be cured with the aid of the emitter 11 or with the aid of another drier, for instance an oven, before the master die 2 is removed from the blank so that the film is completely cured when the master die 2 is removed from the blank 5.

The negative 8 created on the completed tool plate 1 forms a micro-relief for embossing holograms in a rotary process in a printing press. The tool plate 1 is mounted to a cylinder in the printing press to emboss the micro-relief into a UV varnish on a passing sheet of printing material. The UV varnish is subsequently cured in the printing press, creating a hologram on the sheet of printing material.

The tool plate 1 may also be used to create holograms in accordance with the process and using the device described in DE 10 201 3016 117 A1, corresponding to U.S. Patent Application US 2014/0109782, which is hereby incorporated by reference herein.

In accordance with a modified, non-illustrated version, two guiding strips or guiding lines in the form of adhesive strips may be applied to that side of the master die 2 that carries the surface structure 3. The guiding lines are close and parallel to the lateral edges of the master die 2, one guiding line being close to one lateral edge and the other guiding line being close to the other lateral edge. The lateral edges are understood to be those edges of the master die 2 that are perpendicular to the geometric axis of rotation of the roller 9 as the master die passes through the pressing nip 7. The guiding lines that extend close to the lateral edges along the entire length of the master die 2 form spacer lines that assist in the adjustment of the film thickness of the curable layer 6 in the pressing nip 7. The guiding lines are effective if both the master die 2 and the blank 5 have a comparatively high torsional stiffness, i.e. if they are plates, for instance. If the blank 5 is a comparatively thin foil of a thickness of less than 0.6 mm, for instance, and of insufficient torsional stiffness, the use of the guiding lines is not recommended.

1. A method for manufacturing a tool plate for treating a printing substrate, the method comprising the following steps:
pressing together a master die having a surface structure and a blank of the tool plate coated with a cured layer, in a pressing nip;
trapping a curable layer between the master die and the blank;
applying the curable layer to the cured layer of the blank to form a negative of the surface structure in the curable layer in a molding process; and
subsequently curing the curable layer.

2. The method according to claim 1, wherein the master die is a plate or a foil.

3. The method according to claim 1, wherein the tool plate is a printing forme or an embossing die.

4. The method according to claim 1, wherein the negative is a micro-relief that is only visible or a haptic relief that is also perceptible to the touch.

5. The method according to claim 1, which further comprises forming the pressing nip by a roller and a counter-element shaped as a plate or a cylinder.

6. The method according to claim 1, wherein the tool plate is an embossing plate and the blank is a printing plate blank for an offset printing process carried out without water or dampening solution.

7. The method according to claim 1, wherein the master die is a nickel master.

8. The method according to claim 1, wherein the cured layer and the curable layer are formed of the same type of material.

9. The method according to claim 8, wherein the type of material is silicone.

10. A printing machine tool plate, comprising:
an embossing die for micro-embossing in a printing press, said embossing die having a curable layer applied to a cured layer of a blank as a negative of a surface structure molded in the curable layer and cured.

11. An embossing die for embossing holograms, the embossing die comprising:
a plurality of cured layers including an uppermost silicone layer having a micro-relief for embossing the holograms.
